(19) United States
(12) Patent Application Publication
(10) Pub. No.: US 2020/0257276 A1
(43) Pub. Date: Aug. 13, 2020

(54) Obtaining of Packaging Plant Status Data

(71) Applicant: SIG Technology AG, Neuhausen am Rheinfall (CH)

(72) Inventors: Matthias Eickhoff, Alsdorf (DE); Sascha Meyer, Wegberg (DE)

(21) Appl. No.: 16/482,530

(22) PCT Filed: Feb. 6, 2018
(86) PCT No.: PCT/EP2018/052937

§ 371 Date: Jul. 31, 2019

(30) Foreign Application Priority Data
Feb. 15, 2017 (DE) 10 2017 102 989.3

(51) Int. Cl. G05B 19/418

(52) U.S. Cl. CPC G05B 19/41855; G05B 2219/45048

(57) ABSTRACT

A method, server device, and system obtaining packaging plant status data includes a data input interface which obtains a first instance of a packaging plant data switch, wherein the first packaging plant status data represent at least one first status value of a packaging plant. At least one first status value represented by the first packaging plant status data is stored in a persistent memory by a data storage interface. The first instance and each further instance of the packaging plant data switch is notified by the first instance that the first packaging plant status data representing at least the first status value have been obtained. Processing of the first packaging plant status data and/or of the first status value by the first instance and each further instance of the packaging plant data switch is carried out in response to the notifying.

### FIELD

Exemplary embodiments of the invention relate to obtaining of packaging plant status data by an instance of a packaging plant data switch.

### BACKGROUND

Packaging plants are known in which a large number of different components are used, for example heating systems, filling machines, applicators for attaching closures and/or drinking straws, switch points, case packers and cartoners. In most cases these components are produced by different manufacturers and provide packaging plant data, for example packaging plant status data which are representative of the status of the component in question, in different data formats and/or via different data interfaces for processing by other components of the packaging plant. Components produced by different manufacturers also provide different packaging plant datasets.

Summary of a number of exemplary embodiments of the invention

One problem with these packaging plants is therefore that, due to the different data formats used, the packaging plant data provided by the components of the packaging plant cannot be processed further and evaluated in a standardised way, so that individual solutions for further processing and evaluation of the packaging plant data need to be developed for each packaging plant.

Packaging plants are also frequently subsequently expanded, so that the solutions for further processing and evaluation of the packaging plant data also need to be expanded correspondingly. In particular, in most cases the processing capacity of these solutions needs to be increased in the event of a subsequent expansion, since the expansion also generates additional packaging plant data which need to be further processed and/or evaluated.

The present invention addresses the problem of overcoming one or more of the disadvantages described above.

According to the invention, a method is disclosed which comprises the following:
obtaining of first packaging plant status data by a data input interface of a first instance of a packaging plant data switch, wherein the first packaging plant status data represent at least one first status value of a packaging plant;
storing and/or causing of storing of the at least one first status value represented by the first packaging plant status data in a persistent memory by a data storage interface of the first instance of the packaging plant data switch;
notifying and/or causing of notifying of the first instance and of each further instance of the packaging plant data switch by the first instance that the first packaging plant status data representing at least the first status value have been obtained;
processing of the first packaging plant status data and/or of the first status value by the first instance and each further instance of the packaging plant data switch in response to the notifying.

The method according to the invention is for example a method for obtaining packaging plant status data by an instance of a packaging plant data switching system.

Furthermore, according to the invention a computer program is disclosed which comprises program instructions which cause a processor to perform and/or control the method according to the invention when the computer program is executed by the processor. Either all steps of the method can thereby be controlled or all steps of the method can be performed, or one or more steps can be controlled and one or more steps performed.

In this specification, a processor should be understood to mean, inter alia, control units, microprocessors, micro control units such as microcontrollers, digital signal processors (DSPs), application-specific integrated circuits (ASICs) or field programmable gate arrays (FPGAs).

The computer program can for example be distributable via a network such as the internet, a telephone or mobile phone network and/or a local network. The computer program can at least partially comprise software and/or firmware of a processor. It can also be implemented at least partially as hardware.

The computer program can for example be stored on a computer-readable storage medium, for example a magnetic, electrical, optical and/or other storage medium. The storage medium can for example be part of the processor, for example a (non-volatile/persistent or volatile) program memory of the processor or a part thereof. The storage medium can for example be a tangible or physical storage medium.

Furthermore, according to the invention a server device is disclosed which is configured to perform and/or control the method according to the invention or comprises respective means for performing and/or controlling the steps of the method according to the invention. Either all steps of the method according to the invention can thereby be controlled by said means or all steps of the method according to the invention can be performed by said means, or one or more steps can be controlled by said means and one or more steps performed by said means. Different steps can, optionally, be performed or controlled by different means.

Furthermore, according to the invention a server system with several server devices and/or several virtual servers is disclosed which is configured to perform and/or control the method according to the invention or comprises respective means for performing and/or controlling the steps of the method according to the invention. The server devices and/or the virtual servers are for example thereby configured to perform and/or control the method according to the invention jointly. It should be understood that either all steps of the method according to the invention are controlled by the means of the server devices and/or the virtual servers or all steps of the method according to the invention are performed by the means of the server devices and/or the virtual servers, or one or more steps are controlled by the means of the server devices and/or the virtual servers and one or more steps performed by the means of the server devices and/or the virtual servers. Different steps can, optionally, be performed or controlled by different means of different server devices and/or the virtual servers. The server devices and/or the virtual servers of the server system can be located in the same place or in different places. For example, the server devices and/or the virtual servers of the server system can form a server cloud and/or a distributed system. Several virtual servers can be run simultaneously on one server device. A virtual server should thereby be understood to mean the simulation, in software and/or hardware terms, of the hardware architecture of a (physical) server device by the hosting server device.

The means of the disclosed server device(s) can comprise hardware and/or software components. The means can for example comprise at least one memory with program instructions of a computer program (for example of the computer program according to the invention) and at least one processor configured to execute program instructions from the at least one memory. Accordingly, according to the invention at least one server device should also be understood as being disclosed which comprises at least one processor and at least one memory containing program instructions, wherein the at least one memory and the program instructions are configured, together with the at least one processor, to cause the server device to perform and/or control the method according to the invention, at least partially (for example on its own or jointly with several server devices of the server system).

Furthermore, according to the invention a system is disclosed which comprises the following:
a server device according to the invention or a server system according to the invention; and
a packaging plant.

The features and properties of the method according to the invention, of the computer program according to the invention, of the server device according to the invention, of the server system according to the invention as well as of the system according to the invention are explained in the following, in some cases by way of example.

As disclosed above, a packaging plant should be understood to refer to a plant for packaging goods such as, for example, foodstuffs. In particular, a packaging plant should be understood to refer to a beverages filling plant and/or a part of a beverages filling plant. A large number of different components are frequently used in such plants, for example heating systems (for example heating systems for ultra-high heating of the filled product), filling machines, applicators for attaching closures and/or drinking straws, switch points, case packers and cartoners. Different applications run on these components (for example in the form of a computer program executed by a processor in these components). The different components and applications of the packaging plant provide packaging plant data (in particular packaging plant status data) in different data formats for processing by other components and/or applications of the packaging plant.

A packaging plant data switch should for example be understood to mean a function, provided by a server device or a server system (for example the server device according to the invention or the server system according to the invention), allowing the communication of packaging plant status data between different applications and/or components of a packaging plant. For example, the packaging plant data switch is provided through a computer program (for example the computer program according to the invention) executed by a processor of the server device or of the server system. For example, the computer program is a middleware program and/or a service layer program.

An instance of the packaging plant data switch is for example the part of the packaging plant data switch provided by a server device or a virtual server. For example, an instance of the packaging plant data switch is provided by a server device or a virtual server if a corresponding computer program (for example the computer program according to the invention) runs on the server device (for example is executed by a processor of the server device) or the virtual server. For example, if it is provided by a single server device, the packaging plant data switch only has one instance (i.e. the first instance). If, on the other hand, the packaging plant data switch is provided by multiple server devices of a server system, it can for example have multiple instances (i.e. the first instance and one or more further instances).

One or more instances (for example each instance) of the packaging plant data switch (for example the first instance) provide, for example, a respective data input interface for communication with other components and/or applications of the packaging plant. It should be understood that the respective instance of the packaging plant data switch (for example the first instance) can communicate directly as well as indirectly, by the data input interface, with the other components and/or applications of the packaging plant (it can for example obtain data from the other components and/or applications of the packaging plant and/or send error and/or confirmation messages to other components and/or applications of the packaging plant).

Direct communication should for example be understood to mean that another component and/or application of the packaging plant communicates directly with the respective data input interface of the respective instance (for example the data input interface of the first instance). An indirect communication takes place, for example, if another component and/or application of the packaging plant communicates with the respective data input interface of the respective instance (for example the data input interface of the first instance) via a program module (for example a plug-in). Such a program module is for example adapted to the packaging plant and/or the other component and/or application of the packaging plant. For example, a program module is configured to prepare and/or convert (for example convert into a specified data format) data obtained from the other component and/or application of the packaging plant and then pass it on to the respective data input interface of the respective instance (for example the data input interface of the first instance). Alternatively or additionally, such a program module can for example be configured to prepare, process and/or convert (for example convert into a specified data format) confirmation messages and/or error messages obtained from the data input interface and then if necessary pass these on to the other component and/or application of the packaging plant. This is for example advantageous in order to make it possible for the packaging plant data switch to further process and evaluate the data in a standardised data format. In order to be able to include a new component and/or application in the packaging plant data switch it is therefore simply necessary to develop a corresponding program module.

By the data input interface, the respective instance of the packaging plant data switch (for example the first instance) can obtain packaging plant status data (for example the first packaging plant status data) from other components and/or applications of the packaging plant. For example, the data input interface of the respective instance of the packaging plant data switch (for example the first instance) is configured to obtain packaging plant status data (for example the first packaging plant status data), for example packaging plant status data in a specified data format.

That the first packaging plant status data represent at least one first status value of a packaging plant should for example be understood to mean that that the first packaging plant status data contain the first status value and/or a representation of the first status value. It should be understood that, in addition to the first status value and/or a representation of the first status value, the packaging plant status data can contain one or more further status values or representations of status values, wherein the status values and/or representations of status values can be contained in the status data in any sequence (for example, the first status value and/or a representation of the first status value can be contained at any point in the status data and need not be contained in first place in the status data).

The first packaging plant status data can for example also contain metadata which describe the first packaging plant status data and/or the first status value. If, in addition to the first status value and/or a representation of the first status value, the packaging plant status data contain one or more further status values or representations of status values, the first packaging plant status data can also contain metadata which describe the further status values. Examples of such metadata include for example an origin of the first packaging plant status data and/or of the first status value, a destination of the first packaging plant status data and/or of the first status value and/or a unit of the first status value and/or a status to which the first status value relates.

A status value of a packaging plant should for example be understood to be a value characteristic of a current and/or a past status of the packaging plant and/or a component of the packaging plant. Examples of such a status value are for example a measured value captured by a sensor of the packaging plant and/or a component of the packaging plant and/or a characteristic value of the packaging plant and/or a component of the packaging plant, for example a plant and/or component output (for example packagings/hour) and/or an overall equipment effectiveness (OEE) and/or a consumption of energy and/or materials.

The at least one first status value represented by the first packaging plant status data is for example stored in a persistent memory which is not part of the packaging plant data switch. For example, the persistent memory is part of a database system separate from the packaging plant data switch. The persistent memory serves for example to permanently store the status values obtained by the packaging plant data switch. For example, historical and current status values for different statuses of the packaging plant are stored in the persistent memory. A current status value should thereby be understood to mean a value representative of a current status of the packaging plant. This is for example the status value for this status which is represented by packaging plant status data most recently obtained for this status by an instance of the packaging plant data switch. Accordingly, a historical status value for a status is for example a status value represented by packaging plant status data obtained previously (i.e. before the packaging plant status data most recently obtained for this status) by the packaging plant data switch.

For example, one or more instances (for example each instance) of the packaging plant data switch (for example the first instance) provides a respective data storage interface for communication with the persistent memory. It should be understood that the respective instance of the packaging plant data switch (for example the first instance) can communicate directly as well as indirectly with the persistent memory by the data storage interface (for example sending data and/or values which are to be stored to the persistent memory and/or receiving storage error and/or storage confirmation notifications from the persistent memory and/or can retrieve stored data and/or values from the persistent memory). As disclosed above for the data input interface, the communication can thereby take place both directly as well as indirectly (for example via a program module such as a database module and/or a plug-in).

Causing storage of the at least one first status value represented by the first packaging plant status data in the persistent memory by a data storage interface of the first instance of the packaging plant data switch should for example be understood to mean that the data storage interface of the first instance of the packaging plant data switch communicates the first status value to the persistent memory (indirectly or directly) for storage in the persistent memory.

Notifying the first instance and each further instance of the packaging plant data switch comprises for example the communication of a notification to the first instance and each further instance of the packaging plant data switch that the first packaging plant status data representing at least the first status value have been obtained , wherein the notification contains the first packaging plant status data and/or the first status value.

Alternatively, it can also be the case that the notification does not contain the first packaging plant status data and/or the first status value. In this case the instances of the packaging plant data switch may obtain the first packaging plant status data and/or the first status value from the persistent memory by the respective data storage interface of the respective instance of the packaging plant data switch (for example, a corresponding query may be communicated to the persistent memory by the respective data storage interface and the first packaging plant status data and/or the first status value may be obtained as a reply to the query).

For example, the notification of the first instance and each further instance of the packaging plant data switch takes place at least substantially in parallel and/or at least substantially simultaneously.

Causing notification of the first instance and of each further instance of the packaging plant data switch that the first packaging plant status data representing at least the first status value have been obtained should for example be understood to mean that the first instance causes the first instance and each further instance of the packaging plant data switch to be notified (for example in that it calls and/or uses a corresponding function such as a message bus).

In that the first instance notifies each further instance of the packaging plant data switch and also itself and/or causes the notification that the first packaging plant status data representing at least the first status value were obtained, it can be ensured that the first instance and each further instance of the packaging plant data switch obtain this notification at least substantially simultaneously. This is for example advantageous in order to a guarantee a high data consistency between the different instances of the packaging plant data switch. Such a high data consistency is for example necessary in order for packaging plant status data to be processed at all by different instances of the packaging plant data switch because, if such a high data consistency were not guaranteed, different instances of the packaging plant data switch could arrive at different processing results. Specifically, the possibility that the packaging plant data switch can run on different instances is advantageous in order to be able to subsequently adapt the processing capacity of the packaging plant data switch without any problem by removing and/or adding an instance of the packaging plant data switch.

Only in response to the notification are the first packaging plant status data and/or the first status value processed by the first instance and each further instance of the packaging plant data switch; in this way it is ensured that the first instance carries out the processing of the first packaging plant status data and/or of the first status value at least substantially simultaneously with the further instances of the packaging plant data switch. This too is advantageous in order to guarantee a high data consistency between the different instances of the packaging plant data switch.

Further features and properties of the method according to the invention, of the computer program according to the invention, of the server device according to the invention, of the server system according to the invention as well as of the system according to the invention are explained in the following with reference to exemplary embodiments of the invention.

According to an exemplary embodiment of the invention, the processing of the first packaging plant status data and/or of the first status value by the first instance and each further instance of the packaging plant data switch comprises:
storing and/or causing of storing of the status value in a cache memory of the respective instance of the packaging plant data switch.

A cache memory of an instance of the packaging plant data switch contains for example only a limited number of status values for different statuses of the packaging plant. For example, a cache memory of the packaging plant data switch only holds current status values for different statuses of the packaging plant. It should be understood that, in exemplary embodiments, in addition to the current status values for different statuses of the packaging plant, a cache memory of the packaging plant data switch may also contain a limited number of historical status values for the different statuses of the packaging plant. The cache memory serves for example as a cache, in order to avoid that the respective instance of the packaging plant data switch needs to access the persistent memory in order to access each status value.

For example, the first instance and each further instance of the packaging plant data switch in each case comprises a cache memory. For example, the first instance and each further instance of the packaging plant data switch comprises its own cache memory. For example, the cache memory of the first instance and each further instance of the packaging plant data switch is a part of a memory (for example of a program memory and/or main memory) of the server device which provides the respective instance of the packaging plant data switch, or of the virtual server which provides the respective instance of the packaging plant data switch.

According to an exemplary embodiment of the invention, the processing of the first packaging plant status data and/or of the first status value by the first instance and each further instance of the packaging plant data switch comprises:
checking whether one or more components and/or applications of the packaging plant have subscribed to the first status value with the respective instance of the packaging plant data switch; and
notifying of the components and/or applications of the packaging plant which have subscribed to the first status value by the respective instance of the packaging plant data switch.

For example, the first instance and/or one or more further instances (for example each instance) of the packaging plant data switch provides a respective access interface via which the one or more components and/or applications of the packaging plant can subscribe to one or more status values. For example, corresponding subscription data are stored in the cache memory of the first instance and of each further instance of the packaging plant data switch which are indicative as to whether one or more components and/or applications of the packaging plant have subscribed to the first status value with the respective instance of the packaging plant data switch.

The notification of the components and/or applications of the packaging plant which have subscribed to the first status value comprises for example the communication of the first packaging plant status data and/or of the first status value to the respective component and/or application of the packaging plant. For example, the notification of the components and/or applications of the packaging plant takes place, at least in some cases, at least substantially in parallel and/or at least substantially simultaneously. It should be understood that the notification of the components and/or applications of the packaging plant can, at least in some cases, also take place consecutively. For example, the notification of the components and/or applications of the packaging plant can take place through the aforementioned access interface of the respective instance of the packaging plant data switch.

The notified components and/or applications of the packaging plant are for example, at least in some cases, components and/or applications for monitoring and/or controlling the packaging plant. For example, these components and/or applications are, at least in some cases, configured to monitor and/or control the packaging plant and/or a part of the packaging plant, at least in some cases on the basis of the first packaging plant status data and/or the first status value.

According to an exemplary embodiment of the invention, the notification of the first instance and each further instance of the packaging plant data switch that the first packaging plant status data representing at least the first status value have been obtained takes place through a message bus. For example, the first instance of the packaging plant data switch causes the message bus to notify the first instance and each further instance of the packaging plant data switch accordingly.

A message bus should for example be understood to be a communication platform which makes possible message-based communication within a distributed system (for example the server system according to the invention). The message bus is for example provided by a server device and/or a virtual server (for example a server device and/or a virtual server of the server system according to the invention).

This is for example advantageous since such a message bus coordinates and monitors the notification of the first instance and each further instance of the packaging plant data switch in order for example to ensure an at least substantially simultaneous notification of the instances.

According to an exemplary embodiment of the invention, the notification of the first instance and each further instance of the packaging plant data switch that the first packaging plant status data representing at least the first status value have been obtained takes place via a memory. For example, the notification comprises the storing and/or causing storing of a corresponding notification in the memory by the first instance and the subsequent retrieval (for example through a read-access) of the notification from the memory by the first instance and each further instance of the packaging plant data switch.

This embodiment also allows the notification of instances which are not available at present. However, a coordination and monitoring of the notification in order to ensure an at least substantially simultaneous notification of the instances can only be achieved at great expense.

According to an exemplary embodiment of the invention, the notification of the first instance and each further instance of the packaging plant data switch that the first packaging plant status data representing at least the first status value have been obtained takes place directly via one or more communication paths between the first instance and each further instance of the packaging plant data switch. The communication paths can for example be communication connections via a communication network such as, for example, an Ethernet network or a real-time Ethernet network.

This embodiment can be implemented simply, since use frequently needs to be made of an existing communication network. However, it requires that the instances themselves coordinate and monitor the notification in order for example to ensure an at least substantially simultaneous notification of the instances.

According to an exemplary embodiment of the invention, the method according to the invention further comprises:
obtaining, by the data storage interface (for example the data storage interface of the first instance of the packaging plant data switch), of a storage confirmation notification that the at least one first status value represented by the first packaging plant status data has been stored in the persistent memory, wherein the notifying and/or causing of notifying of the first instance and each further instance of the packaging plant data switch by the first instance only takes place if the storage confirmation notification has been obtained previously.

For example, the persistent memory is configured to communicate a corresponding storage confirmation notification to the data storage interface of the first instance of the packaging plant data switch if the at least one first status value represented by the first packaging plant status data has been stored in the persistent memory. The persistent memory can be further configured to communicate a corresponding storage error notification to the data storage interface of the first instance of the packaging plant data switch if the at least one first status value represented by the first packaging plant status data was not stored in the persistent memory. If such a storage error notification is obtained by the data storage interface, the method according to the invention is for example discontinued and/or the step of storing and/or causing of storing of the at least one first status value represented by the first packaging plant status data in the persistent memory is repeated at a later time.

Because the notifying and/or causing of notifying of the first instance and each further instance of the packaging plant data switch by the first instance only takes place if the storage confirmation notification has been obtained previously, a high data consistency between the different instances of the packaging plant data switch and the persistent memory can be guaranteed.

According to an exemplary embodiment of the invention, the persistent memory is configured to permanently store current and historical status values of the packaging plant. For example, as disclosed above, historical and current status values for different statuses of the packaging plant are stored in the persistent memory.

According to an exemplary embodiment of the invention, the packaging plant data switch is provided by one or more server devices and/or by one or more virtual servers. An instance of the packaging plant data switch is for example the part of the packaging plant data switch provided by a server device or a virtual server.

According to an exemplary embodiment of the invention, the first instance and each further instance of the packaging plant data switch in each case runs on different server devices and/or virtual servers. In other words, each of the instances runs on a different server device and/or a different virtual server. An instance which runs on a server device and/or a virtual server should thereby be understood to be the instance provided by the respective server device and/or the respective server.

According to an exemplary embodiment of the invention, the at least one first status value of the packaging plant represents a measured value captured by a sensor of the packaging plant.

For example, the first status value can contain the first measured value and/or correspond to the first measured value. However, alternatively or additionally, the first status value can for example also contain a count value and/or a truth value. Such a count value can for example represent the frequency with which the first measured value is captured by the sensor; for example, such a truth value states whether the first measured value is greater than a threshold value and/or less than a threshold value and/or equal to a threshold value.

Examples of a sensor for capturing the first measured value are for example a temperature sensor, a photoelectric barrier sensor, a pressure sensor, a humidity sensor, a camera, a voltage sensor, a current sensor, a throughflow sensor and/or a filling level sensor.

For example, the method according to the invention further comprises: - capturing of at least the first measured value by a sensor of the packaging plant; and communicating and/or causing of communicating of the first packaging plant status data to the data input interface of the first instance of the packaging plant data switch.

The examples and exemplary embodiments described above should also be understood as being disclosed in any combination with one another.

Further advantageous exemplary variants of the invention are explained in the following detailed description of a number of exemplary embodiments, in particular in combination with the figures. However, the figures enclosed with the application are only intended be used for illustration purposes and not to define the scope of protection of the invention.

The attached drawings are not necessarily true to scale and are simply intended to illustrate the general concept of the present invention by way of example. In particular, features which are contained in the figures should in no way be considered as a necessary element of the present invention.

### IN THE DRAWINGS

FIG. 1 shows a schematic representation of an exemplary embodiment of a system according to the invention;

FIGS. 2a-2b show a flow chart and optional steps of an exemplary embodiment of a method according to the invention;

FIG. 3 shows a schematic representation of an exemplary embodiment of a server device according to the invention; and

FIG. 4 shows exemplary embodiments of storage media.

### DETAILED DESCRIPTION OF A NUMBER OF EXEMPLARY EMBODIMENTS OF THE INVENTION

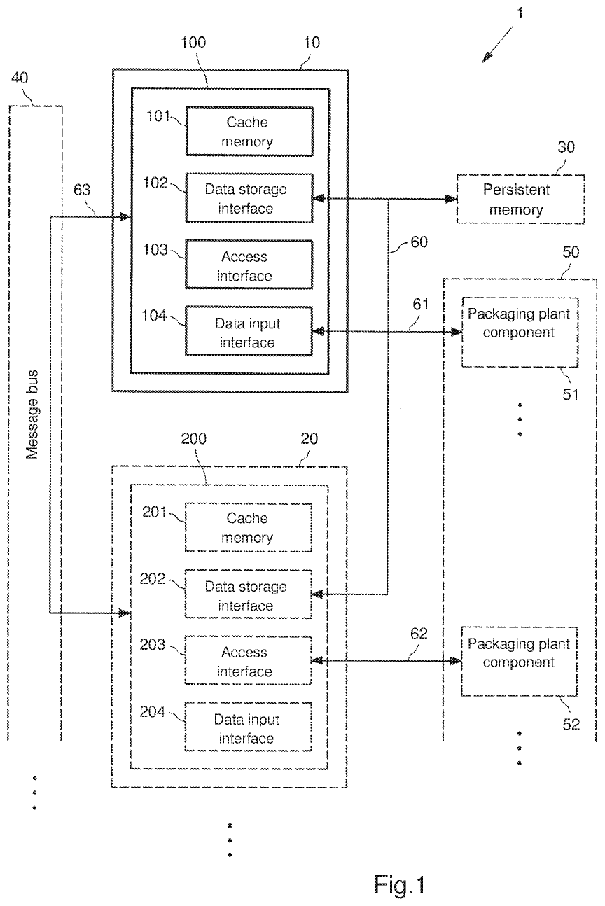

FIG. 1 shows a schematic representation of an exemplary embodiment of a system 1 according to the invention. The system 1 comprises a first server device 10, an optional second server device 20, an optional persistent memory 30, an optional message bus 40 as well as a packaging plant 50 with the exemplary components 51 and 52.

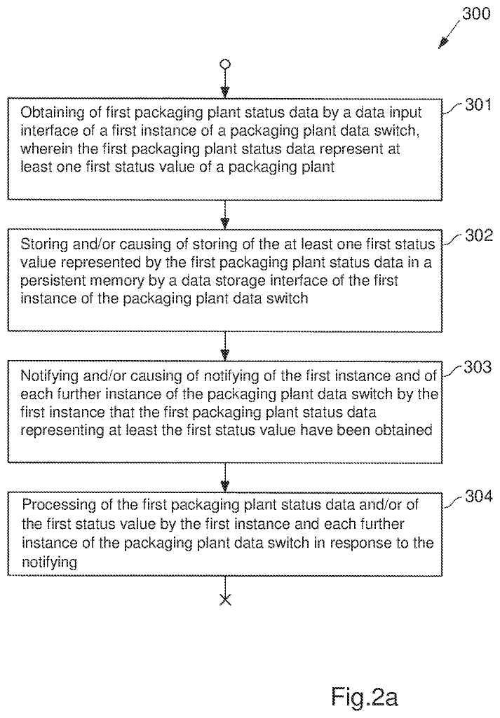

For example, the first server device 10 and the second server device 20 form a server system according to the invention. The first server device 10 provides a first instance 100 of a packaging plant data switch, and the second server device 20 provides a further instance 200 of the packaging plant data switch. For example, a corresponding computer program (for example the computer program according to the invention) runs on each of the server devices 10 and 20 which causes the respective server device 10 or 20 to provide the instance 100 or 200 of the packaging plant data switch. The computer program can for example be stored in a memory of the server device 10 and/or 20 and can comprise corresponding program instructions which are executed by a processor of the server devices 10 and/or 20 and cause the server device 10 and/or 20 to provide the instance 100 or 200 of the packaging plant data switch and/or perform the steps of the method according to the invention (for example the steps shown in the flow chart 300 in FIG. 2). It should be understood that the system 1 and/or the server system can, in addition to the server devices 10 and 20, also comprise further server devices which in each case provide a further instance of the packaging plant data switch.

For example, the packaging plant 50 is a beverages filling plant. Accordingly, the components 51 and 52 can in each case be a filling machine, an applicator for attaching closures and/or drinking straws, a switch point, a case packer and/or a cartoner. It should be understood that the packaging plant 50 can comprise further components (for example more of the above components). Different applications can run on these components (for example in the form of a computer program executed by a processor of this component) which, inter alia, provide packaging plant status data for processing by other components and/or applications of the packaging plant.

The packaging plant status data contain for example one or more status values of the packaging plant 50 and/or one or more representations of one or more status values of the packaging plant 50. In addition, the packaging plant status data can for example also contain metadata which describe the packaging plant status data and/or the status values and/or representation of status values contained therein. Examples of such metadata include for example an origin of the packaging plant status data and/or of the status value, a destination of the packaging plant status data and/or of the status value and/or a unit of the status value and/or a status to which the status value relates.

A status value of a packaging plant should for example be understood to be a value characteristic of a current and/or a past status of the packaging plant and/or a component of the packaging plant. Examples of such a status value are for example a measured value (for example a temperature value) captured by a sensor of the packaging plant and/or a component of the packaging plant (for example a temperature sensor) and/or a characteristic value of the packaging plant and/or a component of the packaging plant, for example a plant and/or component output (for example packagings/hour) and/or an overall equipment effectiveness (OEE).

As shown in FIG. 1 by way of example for the instances 100 and 200 of the packaging plant data switch, each instance of the packaging plant data switch can comprise a cache memory for storing current status values for different statuses of the packaging plant 50 (see reference numbers 101 and 201), a data storage interface for communication with the persistent memory 30 (see reference numbers 102 and 202), an optional access interface via which the components and/or applications of the packaging plant 50 can subscribe to one or more status values (see reference numbers 103 and 203) and a data input interface for communication with the components and/or applications of the packaging plant 50 (see reference numbers 104 and 204).

Exemplary communication paths 60, 61 and 62 between corresponding interfaces of the instances 100 and 200 of the packaging plant data switch and the components 51, 52 of the packaging plant 50 as well as the persistent memory 30 are shown in FIG. 1.

The communication with the components and/or applications of the packaging plant 50 as well as the persistent memory 30 can take place both indirectly as well as directly. Direct communication should for example thereby be understood to mean that a component and/or application of the packaging plant 50 or the persistent memory 30 communicates directly with the respective interface (for example the data input interface 104 or the data storage interface 102). Indirect communication takes place for example if a component and/or application of the packaging plant 50 or the persistent memory 30 communicates with the respective interface (for example the data input interface 104 or the data storage interface 102) via a program module (for example a plug-in). As disclosed above, such a program module is for example adapted to the other component and/or application of the packaging plant 50 and/or the persistent memory 30.

The respective instance of the packaging plant data switch can, for example, obtain packaging plant status data from the components and/or applications of the packaging plant 50 by the data input interface. For example, the data input interfaces 104 and 204 of the instances 100 and 200 of the packaging plant data switch are configured to obtain packaging plant status data in a specified data format. If a component and/or application of the packaging plant 50 packaging plant communicates status data to the data input interface 104 or 204 in another data format, a program module can for example be provided in the communication path which converts the packaging plant status data into the specified data format.

The persistent memory 30 is a database system separate from the packaging plant data switch. For example, the persistent memory 20 is provided by a corresponding database server device. The persistent memory 30 serves for example to permanently store the status values obtained from the packaging plant data switch. For example, historical and current status values for different statuses of the packaging plant 50 are stored in the persistent memory 30. By the data storage interfaces 102 and 202, the instances 100 and 200 of the packaging plant data switch can for example communicate a status value to the persistent memory 30 for storage in the persistent memory 30 and/or obtain storage confirmation and/or storage error notifications from the persistent memory 30. A program module can thereby be provided in the respective communication path in order, for example, to make possible a data format conversion.

Furthermore, the instances of the packaging plant data switch can communicate with one another via the message bus 40, as indicated by the exemplary communication path 63 between the instances 100 and 200 of the packaging plant data switch.

The message bus 40 is for example provided by a server device. The message bus 40 should for example be understood to be a communication platform which makes possible a message-based communication between the instances 100 and 200 of the packaging plant data switch.

The communication paths 60, 61, 62 and 63 shown in FIG. 1 are for example logical communication paths. These communication paths can run along different communication connections (for example wired and/or wireless communication connections). For example, the individual components 10 to 50 of the system 1 are connected with one another in communication terms via one or more communication networks and/or bus systems. Examples of such a communication network are an Ethernet network and/or a WLAN network. Ethernet networks are for example specified in the standards of the IEEE 802.3 family; and WLAN is for example specified in the standards of the IEEE-802.11 family. Examples of a bus system are real-time Ethernet networks such as EtherCAT, which are specified, inter alia, in the standards IEC-61158 and IEC-61784-2.

FIG. 2a shows a flow chart 300 with steps of an exemplary embodiment of a method according to the invention. In the following, it is assumed by way of example that the steps 301 to 304 of the flow chart 300 are performed at least by the server device 10, which is part of the system 1 in FIG. 1.

In a step 301, first packaging plant status data are obtained by the data input interface 104 of the first instance 100 of the packaging plant data switch, wherein the first packaging plant status data represent at least one first status value of the packaging plant 50. For example, the first packaging plant status data are obtained from the component 51 via the communication path 61 in step 301. For example, the first status value is a first measured value (for example a temperature value) captured by a sensor (for example a temperature sensor) of the component 51.

In a step 302, the storage of the at least one first status value represented by the first packaging plant status data in the persistent memory is caused by the data storage interface 102 of the first instance 100 of the packaging plant data switch. For example, in step 302 the first status value is communicated to the persistent memory 30 by the data storage interface 102 for storage in the persistent memory 30 via the communication path 60.

Furthermore, in step 302 a storage confirmation notification and/or a storage error notification can for example be obtained from the persistent memory 30 by the data storage interface 102 of the first instance 100 of the packaging plant data switch. For example, the persistent memory 30 is configured to communicate a corresponding storage confirmation notification to the data storage interface 102 if the at least one first status value represented by the first packaging plant status data has been stored in the persistent memory 30. Furthermore, the persistent memory 30 is for example configured to communicate a corresponding storage error notification to the data storage interface 102 if the at least one first status value represented by the first packaging plant status data was not stored in the persistent memory 30 (for example due to an error). If such a storage error notification is obtained by the data storage interface 102, the flow chart 300 is for example discontinued and/or the step 302 repeated at a later time. If, on the other hand, a storage confirmation notification is obtained by the data storage interface 102, the flow chart is for example continued with a step 303.

In the step 303, the first instance 100 and the second instance 200 of the packaging plant data switch are notified by the first instance 100 that the first packaging plant status data representing at least the first status value have been obtained. Alternatively, in the step 303 the first instance 100 can cause the first instance 100 and the second instance 200 of the packaging plant data switch to be notified accordingly.

The notification of the first instance 100 and the second instance 200 of the packaging plant data switch that the first packaging plant status data representing at least the first status value have been obtained comprises for example the communication of the first packaging plant status data and/or the first status value to the first instance 100 and the second instance 200. For example, the first status value is communicated to the first instance 100 and the second instance 200 together with a unique identifier. The unique identifier can for example be determined at least partially depending on metadata contained in the first packaging plant status data.

In order to cause the notification of the first instance 100 and the second instance 200 of the packaging plant data switch, in step 303 the first instance can for example call the message bus 40 and pass on the first status value (for example together with the unique identifier) to the message bus 40. For example, the message bus 40 is configured then to notify the first instance 100 and the second instance 200, at least substantially in parallel and/or at least substantially simultaneously, that the first status value has been obtained, and for example communicate the first status value (for example together with the unique identifier) to the first instance 100 and the second instance 200.

In a step 304, the first packaging plant status data and/or the first status value are then processed by the first instance 100 and the second instance 200 of the packaging plant data switch in response to the notification. In other words, the first instance 100 and the second instance 200 of the packaging plant data switch only process the first packaging plant status data and/or the first status value after they have been notified that the first packaging plant status data representing at least the first status value have been obtained.

The processing in step 304 can for example comprise the optional steps 305 to 307 shown in FIG. 2b. The flow chart 300 then ends.

In the step 305, the first instance 100 and the second instance 200 of the packaging plant data switch store the first status value in their respective cache memories 101 and 201.

In the step 306, the first instance 100 and the second instance 200 of the packaging plant data switch check whether one or more components and/or applications of the packaging plant 50 have subscribed to the first status value with the respective instance of the packaging plant data switch. For example, subscription data are stored in the cache memories 101 and 201 which are indicative of whether one or more components and/or applications of the packaging plant have subscribed to the first status value with the respective instance. For example, the component 52 has subscribed to the first status value with the second instance 200 of the packaging plant data switch.

In the step 307, the components and/or applications of the packaging plant 50 which have subscribed to the first status value are notified by the respective instance of the packaging plant data switch (for example by the access interface of the respective instance of the packaging plant data switch). If the check in step 306 has for example shown that the component 52 has subscribed to the first status value with the second instance 200 of the packaging plant data switch, the access interface 203 communicates the first status value to the component 52 via the communication path 62.

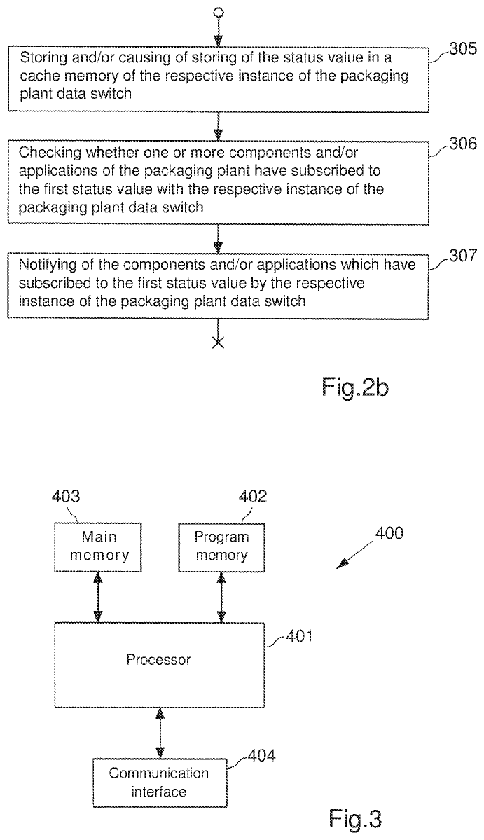

FIG. 3 is a schematic representation of an exemplary embodiment of a server device 400 according to the invention. For example, the server device 10 and/or server device 20 in FIG. 1 correspond to the server device 400.

The server device 400 comprises, by way of example, a processor 401 and, connected with the processor 401, a first memory serving as a program and data memory 402, a second memory serving as main memory 403 and a communication interface 404.

A processor should for example be understood to mean a microprocessor, a micro control unit, a microcontroller, a digital signal processor (DSP), an application-specific integrated circuit (ASIC) or a field programmable gate array (FPGA). It should be understood that the server device 400 can also comprise multiple processors 10.

The processor 401 executes program instructions which are stored in the program memory 402, and for example stores interim results or the like in the main memory 403. For example, the main memory can contain the cache memory (for example the cache memory 101 or 201) of an instance of a packaging plant data switch provided by the server device 400. The program memory 402 contains for example program instructions of a computer program according to the invention which comprises program instructions which cause the processor 401 to perform and/or control the method according to the invention (for example the method according to the flow chart 300 shown in FIG. 2) when the processor 401 executes these program instructions stored in the program memory 402.

For example, the program memory 402 also contains the operating system of the server device 400 which, on starting the server device 400, is at least partially loaded into the main memory 403 and run by the processor 401. In particular, on starting the server device 400 at least one part of the core of the operating system is loaded into the main memory 403 and run by the processor 401.

An example of an operating system is a Windows, UNIX, Linux, Android, Apple iOS and/or MAC OS operating system. In particular, the operating system makes it possible to use the server device 400 for data processing. For example, it manages operating elements such as a main memory and a program memory, makes fundamental functions available to other computer programs, inter alia via programming interfaces , and controls the running of computer programs.

A program memory is for example a non-volatile memory such as a flash memory, a magnetic memory, an EEPROM memory (electrically erasable programmable read-only memory) and/or an optical memory. A main memory is for example a volatile or non-volatile memory, in particular a random access memory (RAM) such as a static RAM memory (SRAM), a dynamic RAM memory (DRAM), a ferroelectric RAM memory (FeRAM) and/or a magnetic RAM memory (MRAM).

The main memory 403 and program memory 402 can also be implemented as one memory. Alternatively, the main memory 403 and/or program memory 402 can in each case be implemented in the form of multiple memories. Furthermore, the main memory 403 and/or program memory 402 can also be part of the processor 401.

In addition, the processor 401 controls the communication interface 404.

A communication interface can for example receive data using a communication technology (via a communication path and/or a communication connection within a communication network) and pass this on to the processor and/or receive data from the processor and send this (via a communication path and/or a communication connection within a communication network) using a communication technology.

Examples of such communication technologies are the communication networks disclosed above and their specifications such as Ethernet networks and/or WLAN networks and/or real-time Ethernet networks such as EtherCAT. An example of a communication interface is, accordingly, a network adapter such as an Ethernet and/or WLAN and/or EtherCAT network adapter.

The components 401 to 404 of the server device 400 are for example connected with one another for communication and/or operating purposes via one or more bus systems (for example one or more serial and/or parallel bus connections).

It should be understood that in addition to the components 401 to 404 the server device 400 can comprise further components (for example a user interface and/or one or more further communication interfaces).

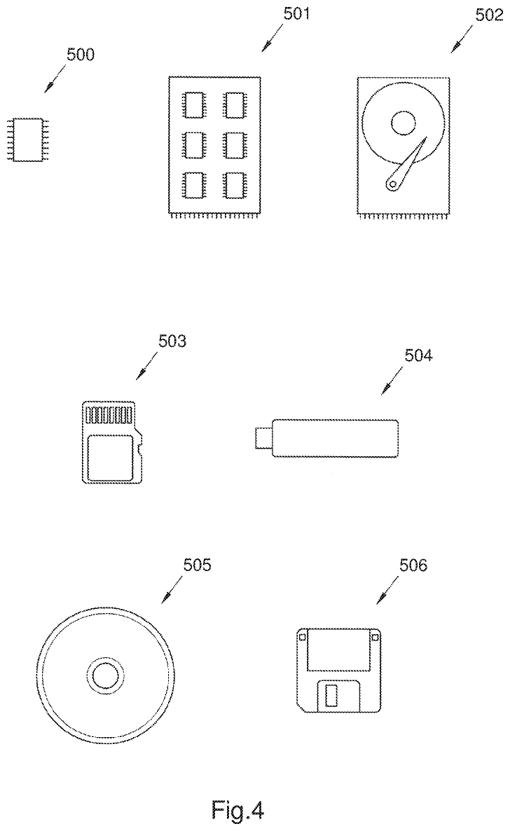

Finally, FIG. 4 shows exemplary embodiments of storage media on which an exemplary embodiment of a computer program according to the invention can be stored. The storage medium can for example be a magnetic, electrical, optical and/or other form of storage medium. The storage medium can for example be part of a processor (for example of the processor 401 in FIG. 3), for example a (non-volatile or volatile) program memory of the processor or a part thereof (for example memory 402 in FIG. 3). Exemplary embodiments of a storage medium are a flash memory 500, an SSD hard drive 501, a magnetic hard drive 502, a memory card 503, a memory stick 504 (for example a USB stick), a CD-ROM or DVD 505 or a diskette 506.

The examples and exemplary embodiments of the present invention described in this specification should also be understood as being disclosed in any combination with one another. In particular, the description of a feature included in an embodiment—unless otherwise expressly stated—should also not be understood in the present case to the effect that the feature is essential or important for the function of the exemplary embodiment. The sequence of the method steps represented in the individual flow charts in this specification is not mandatory, alternative sequences of the method steps are conceivable. The method steps can be implemented in different ways; for example, an implementation in software (through program instructions), hardware or using a combination of both to implement the method steps is conceivable. Terms used in the claims such as “comprise”, “exhibit”, “include”, “contain” and the like do not exclude further elements or steps. The formulation “at least partially” covers both the case “partially” and also the case “completely”. The formulation “and/or” should be understood to the effect that both the alternatives and also the combination thereof is intended to be disclosed, i.e. “A and/or B” means “(A) or (B) or (A and B)”. Within the context of this specification, a plurality of units, persons or the like means multiple units, persons or the like. The use of the indefinite article does not rule out a plurality. A single device can perform the functions of several units or devices referred to in the claims. Reference symbols cited in the claims are not to be regarded as limitations of the means and steps used.

1. A method comprising:
obtaining of first packaging plant status data by a data input interface of a first instance of a packaging plant data switch, wherein the first packaging plant status data represent at least one first status value of a packaging plant;
storing or causing of storing of the at least one first status value represented by the first packaging plant status data in a persistent memory by a data storage interface of the first instance of the packaging plant data switch;
notifying or causing of notifying of the first instance and of each further instance of the packaging plant data switch by the first instance that the first packaging plant status data representing at least the first status value have been obtained;
processing of at least one of the first packaging plant status data or the first status value by the first instance and each further instance of the packaging plant data switch in response to the notifying;
wherein the packaging plant data switch is provided by one or more server devices or by one or more virtual servers; and wherein the first instance and each further instance of the packaging plant data switch in each case run on different server devices or virtual servers.

2. The method according to claim 1, wherein the processing of at least one of the first packaging plant status data the at least one first status value by the first instance and each further instance of the packaging plant data switching system comprises:
storing causing of storing of the status value in a cache memory of the respective instance of the packaging plant data switch.

3. The method according to claim 2, wherein the first instance and each further instance of the packaging plant data switching system comprises a respective cache memory.

4. The method according to claim 1, wherein the processing of at least one of the first packaging plant status data the first status value by the first instance and each further instance of the packaging plant data switch comprises:
checking whether one or more components or applications of the packaging plant have subscribed to the first status value with the respective instance of the packaging plant data switching system; and
notifying of the components or applications of the packaging plant which have subscribed to the first status value by the respective instance of the packaging plant data switch.

5. The method according to claim 1, wherein the notifying by the first instance and each further instance of the packaging plant data switch system takes place through a message bus.

6. The method according to claim 1, the method further comprising:
obtaining, by the data storage interface, of a storage confirmation notification that the at least one first status value represented by the first packaging plant status data has been stored in the persistent memory, wherein the notifying causing of notifying of the first instance and each further instance of the packaging plant data switch by the first instance only takes place if the storage confirmation notification has been obtained previously.

7. The method according to claim 1, wherein the persistent memory is configured for permanently storing current and historical status values of the packaging plant.

8. (canceled)

9. (canceled)

10. The method according to claim 1, wherein the at least one first status value of the packaging plant represents a first measured value captured by a sensor of the packaging plant.

11. The method according to claim 10, the method further comprising:
capturing of at least the first measured value by a sensor of the packaging plant; and
communicating causing of communicating of the first packaging plant status data to the data input interface of the first instance of the packaging plant data switch.

12. A non-transitory computer readable storage medium in which a computer program is stored, the computer program comprising program instructions which cause a processor to perform and or control:
obtaining of first packaging plant status data by a data input interface of a first instance of a packaging plant data switch, wherein the first packaging plant status data represent at least one first status value of a packaging plant;
storing or causing of storing of the at least one first status value represented by the first packaging plant status data in a persistent memory by a data storage interface of the first instance of the packaging plant data switch;
notifying or causing of notifying of the first instance and of each further instance of the packaging plant data switch by the first instance that the first packaging plant status data representing at least the first status value hove been obtained;
processing of at least one of the first packaging plant status data or the first status value by the first instance and each further instance of the packaging plant data switch in response to the notifying;
wherein the packaging plant data switch is provided by one or more server devices or by one or more virtual servers: and wherein the first instance and each further instance of the packaging plant data switch in each case run on different server devices or virtual servers.

13. A server device or a server system comprising multiple server devices the server device or server system comprising at least one processor and at least one memory including computer program code, wherein the at least one memory and the computer program code are configured to. with the at least one processor, cause the server device or server system to perform or control:
obtaining of first packaging plant status data by a data input interface of a first instance of a packaging plant data switch, wherein the first packaging plant status data represent at least one first status value of a packaging plant:
storing or causing of storing of the at least one first status value represented by the first packaging plant status data in a persistent memory by a data storage interface of the first instance of the packaging plant data switch;
notifying or causing of notifying of the first instance and of each further instance of the packaging plant data switch by the first instance that the first packaging plant status data representing at least the first status value have been obtained:
processing of at least one of the first packaging plant status data or the first status value by the first instance and each further instance of the packaging plant data switch in response to the notifying;
wherein the packaging plant data switch is provided by the server device or the server system; and wherein the first instance and each further instance of the packaging plant data switch in each case run on different server devices.

14. A system, comprising:
a server device or a server system according to claim 13; and a packaging plant.

15. The server device or server system according to claim 13, wherein the processing of at least one of the first packaging plant status data or the at least one first status value by the first instance and each further instance of the packaging plant data switching system comprises:
storing or causing of storing of the status value in a cache memory of the respective in-stance of the packaging plant data switch.

16. The server device or server system according to claim 15, wherein the first instance and each further instance of the packaging plant data switching system comprises a respective cache memory.

17. The server device or server system according to claim 13, wherein the processing of at least one of the first packaging plant status data or the first status value by the first instance and each further instance of the packaging plant data switch comprises:
checking whether one or more components or applications of the packaging plant have subscribed to the first status value with the respective instance of the packaging plant data switching system; and
notifying of the components or applications of the packaging plant which have subscribed to the first status value by the respective instance of the packaging plant data switch.

18. The server device or server system according to claim 13, wherein the notifying by the first instance and each further instance of the packaging plant data switch system takes place through a message bus.

19. The server device or server system according to claim 13, wherein the at least one memory and the computer program code are further configured to, with the at least one processor, cause the server device or server system to perform or control:
obtaining, by the data storage interface, of a storage confirmation notification that the at least one first status value represented by the first packaging plant status data has been stored in the persistent memory, wherein the notifying or causing of notifying of the first instance and each further instance of the packaging plant data switch by the first instance only takes place if the storage confirmation notification has been obtained previously.

20. The server device or server system according to claim 13, wherein the persistent memory is configured for permanently storing current and historical status values of the packaging plant.

21. The server device or server system according to claim 13, wherein the at least one first status value of the packaging plant represents a first measured value captured by a sensor of the packaging plant.

22. The server device or server system according to claim 21, wherein the at least one memory and the computer program code are further configured to, with the at least one processor, cause the server device or server system to perform or control:
capturing of at least the first measured value by a sensor of the packaging plant; and
communicating or causing of communicating of the first packaging plant status data to the data input interface of the first instance of the packaging plant data switch.
